(19) United States
(12) Patent Application Publication
(10) Pub. No.: US 2024/0207806 A1
(43) Pub. Date: Jun. 27, 2024

(54) FLOW-THROUGH THRUST AND RADIAL BEARING, HOLDER, AND ASSEMBLY FOR AN AUTOCLAVE REACTOR

(71) Applicant: Chevron Phillips Chemical Company LP, The Woodlands, TX (US)

(72) Inventors: Ryan R. Baskin, Houston, TX (US); Kenneth A. Dooley, Porter, TX (US)

(21) Appl. No.: 18/543,296

(22) Filed: Dec. 18, 2023

Related U.S. Application Data
(60) Provisional application No. 63/477,338, filed on Dec. 27, 2022.

(51) Int. Cl. B01J 19/00; C08F 10/02; F16C 19/54; F16C 35/067

(52) U.S. Cl. CPC B01J 19/0066; C08F 10/02; F16C 19/545; F16C 35/067

(57) ABSTRACT

A holder and assembly for a flow-through thrust and radial bearing in an autoclave reactor, an autoclave reactor containing the flow-through thrust and radial bearing assembly, and a process for making a polymer utilizing the flow-through thrust and radial bearing assembly in an autoclave reactor. The holder and assembly can be positioned in a bottom of the autoclave reactor, and reaction medium can be removed from the autoclave reactor via a first flow channel formed between a bottom of the flow-through thrust and radial bearing and the holder of the assembly and via a second flow channel formed between the inner race and an outer race of the flow-through thrust and radial bearing.

### CROSS-REFERENCE TO RELATED APPLICATIONS

The present application claims priority to U.S. Provisional Patent Application No. 63/477,338 filed Dec. 27, 2022 and entitled “Flow-Through Thrust and Radial Bearing, Holder, and Assembly for an Autoclave Reactor,” which application is incorporated by reference herein in its entirety.

### FIELD OF THE DISCLOSURE

The present disclosure generally relates to autoclave reactors, and more particularly to an agitator that rotates in the autoclave reactor.

### BACKGROUND

Autoclave reactors can be used for the production of low density polyethylene (LDPE). The LDPE produced by autoclave reactors can be used in a variety of products and applications such as film, paper coating, injection molding, and wire/cable insulation.

Autoclave reactors can include an internal agitator for stirring the reaction medium disposed within the reactor vessel. The agitator can have a shaft assembly having paddles extending from a shaft and a high efficiency motor for rotating the shaft. Metallic anti-friction bearings are positioned at the base of the agitator and in the motor of the agitator.

The reliability of the agitator is affected by the harsh reaction conditions within the autoclave reactor, including the high temperatures and pressures required to produce LDPE at commercial rates. The reliability of the agitator is also affected by whether the anti-friction bearings are functioning properly. As the bearings at the base of the agitator begin to fail, the reliability of the bearings in the motor is compromised. As a result, vibrations are generated that adversely affect the components of the agitator and that lead to agitator failure. There is a need for improved agitators in autoclave reactors.

### SUMMARY

In some aspects, the techniques described herein relate to a holder for a flow-through thrust and radial bearing including an outer race and an inner race, wherein each of the outer race and the inner race has a plurality of bearing elements including one or more superhard materials, the holder including: an inlet holding section, a flow-through section, and an outlet section; wherein the inlet holding section is formed in an end of the holder and is configured to receive and hold the outer race of the flow-through thrust and radial bearing; wherein the flow-through section is formed in a middle of the holder between the inlet holding section and the outlet section, wherein the flow-through section has an end fluidly connected to the inlet holding section and has an inner wall tapered to form a flow channel between the inner wall and a bottom of the flow-through thrust and radial bearing, and wherein the outlet section is formed in an opposite end of the holder and is fluidly connected to an opposite end of the flow-through section.

In some aspects, the techniques described herein relate to a flow-through thrust and radial bearing assembly including: a flow-through thrust and radial bearing including an outer race and an inner race, wherein each of the outer race and the inner race has a plurality of bearing elements including one or more superhard materials; and a holder for the flow-through thrust and radial bearing. The holder includes an inlet holding section formed in an end of the holder, a flow-through section formed in a middle of the holder, and an outlet section fluidly connected to an opposite end of the flow-through section. The inlet holding section is configured to receive and hold the outer race of the flow-through thrust and radial bearing. The flow-through section has an end fluidly connected to the inlet holding section and has an inner wall tapered to form a first flow channel between the inner wall and a bottom of the inner race of the flow-through thrust and radial bearing.

In some aspects, the techniques described herein relate to an autoclave reactor including: a housing having a top, a bottom, and a vessel body connected between the top and the bottom; an agitator assembly contained within the housing, wherein the agitator assembly includes a motor and a shaft coupled to the motor; a flow-through thrust and radial bearing connected to a bottom end of the shaft, wherein the flow-through thrust and radial bearing includes an outer race and an inner race, wherein each of the outer race and the inner race has a plurality of bearing elements including one or more superhard materials; and a holder positioned on a bottom of the housing. The holder includes: an inlet holding section formed in an end of the holder, wherein the inlet holding section is configured to receive and hold the outer race of the flow-through thrust and radial bearing; a flow-through section formed in a middle of the holder, wherein the flow-through section has an end fluidly connected to the inlet holding section and has an inner wall tapered to form a first flow channel between the inner wall and a bottom of the inner race of the flow-through thrust and radial bearing; and an outlet section fluidly connected to an opposite end of the flow-through section.

In some aspects, the techniques described herein relate to a process for making low density polyethylene (LDPE), including: mixing, with an agitator assembly contained in a housing of an autoclave reactor, a reaction medium to form the LDPE in the autoclave reactor, wherein a bottom of the agitator assembly is coupled to a flow-through thrust and radial bearing assembly that is positioned on a bottom of the housing of the autoclave reactor; and removing the reaction medium and the LDPE from the autoclave reactor via a first flow channel formed between an inner race and a holder of the flow-through thrust and radial bearing assembly and a second flow channel formed between the inner race and an outer race of the flow-through thrust and radial bearing assembly.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1A illustrates a cross sectional view of an embodiment of a flow-through thrust and radial bearing assembly for an autoclave reactor.

FIG. 1B illustrates a cross sectional view of another embodiment of a flow-through thrust and radial bearing assembly for an autoclave reactor.

FIG. 1C illustrates a cross sectional view of yet another embodiment of a flow-through thrust and radial bearing assembly for an autoclave reactor.

FIG. 2A illustrates an isolated cross sectional view of the holder of the flow-through thrust and radial bearing assembly.

FIG. 2B illustrates an isolated perspective view of the holder.

FIG. 2C illustrates an isolated cross sectional view of the shaft fastener of the flow-through thrust and radial bearing assembly.

FIG. 2D illustrates an isolated perspective view of the shaft fastener.

FIG. 2E illustrates an isolated cross sectional view of another embodiment of the shaft fastener of the flow-through thrust and radial bearing assembly.

FIG. 3 illustrates an isolated perspective view of the outer race.

FIG. 4 illustrates a side view of the inside of an autoclave reactor, showing the flow-through thrust and radial bearing assembly attached to a bottom of the agitator in a bottom of the autoclave reactor.

FIG. 5 illustrates a cross sectional isolated view of the flow-through thrust and radial bearing assembly in the bottom of the autoclave reactor.

### DETAILED DESCRIPTION

It is to be understood that the following disclosure describes aspects, features, structures, and/or functions of the disclosure. Exemplary components, arrangements, and configurations described below are provided merely as examples, and are not intended to limit the scope of the disclosure. Moreover, the exemplary components, arrangements, and configurations described below can be present in any flow-through, e.g., any element from one component, arrangement, or configuration can be used in any other component, arrangement, or configuration without departing from the scope of the disclosure.

Additionally, certain terms are used throughout the following description and claims to refer to particular components. As one skilled in the art will appreciate, the naming convention for the elements described herein is not intended to limit the scope of the claimed subject matter, unless otherwise specifically defined herein. Further, the naming convention used herein is not intended to distinguish between components that differ in name but not function.

The term “autoclave reactor” refers to any vessel for chemical reactions capable of withstanding high temperatures and pressures.

The term “bearing” refers to an element that reduces friction between two or more moving parts of a machine or mechanical apparatus.

The term “paddle” refers to a rod having a broad blade at the end of the rod.

The term “coupled” refers to two items, directly or indirectly, joined, fastened, associated, connected, or formed integrally together either by chemical or mechanical means, by processes including stamping, molding, or welding. What is more, two items can be coupled by the use of a third component such as a mechanical fastener, e.g., a screw, a bolt and optionally a washer and/or a nut, a threaded rod and a nut, a nail, a pin, a staple, a crimp, a snap-fit, a shrink-fit, and/or a rivet; an adhesive; or a solder.

The term “and/or” refers to one or more of items in any combination in a list, such as “A and/or B” means “A, B, or the combination of A and B” and the slash symbol “/” refers to “or” such as “A/B” means “A or B”.

A “polymer” has two or more of the same or different repeating monomer units. A “homopolymer” is a polymer having monomer units that are the same. A “copolymer” is a polymer having two or more monomer units that are different from each other.

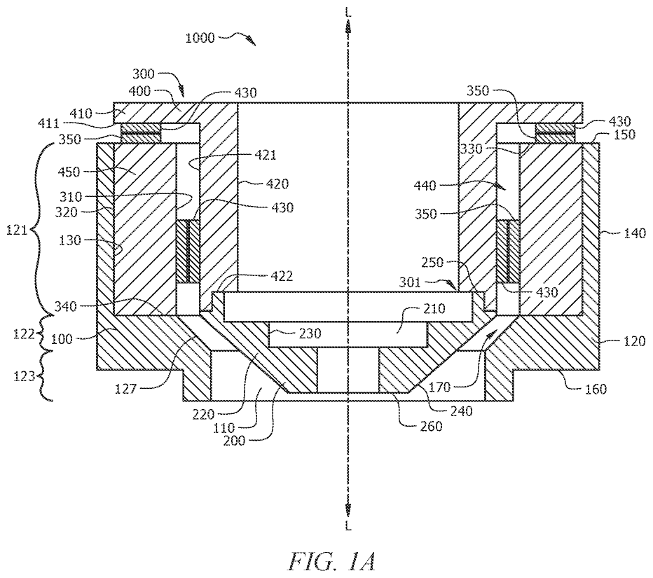

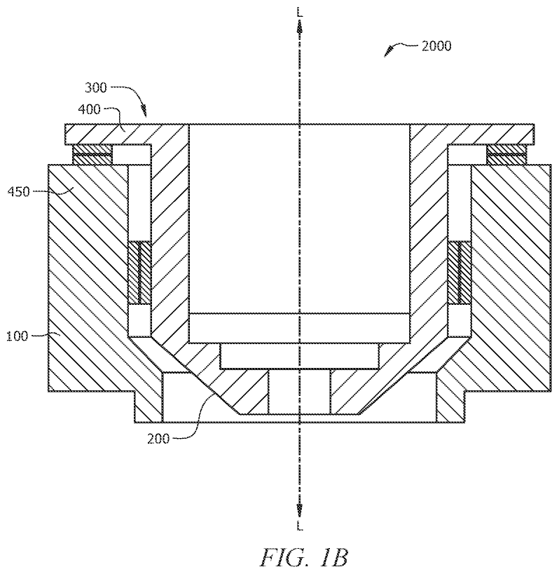

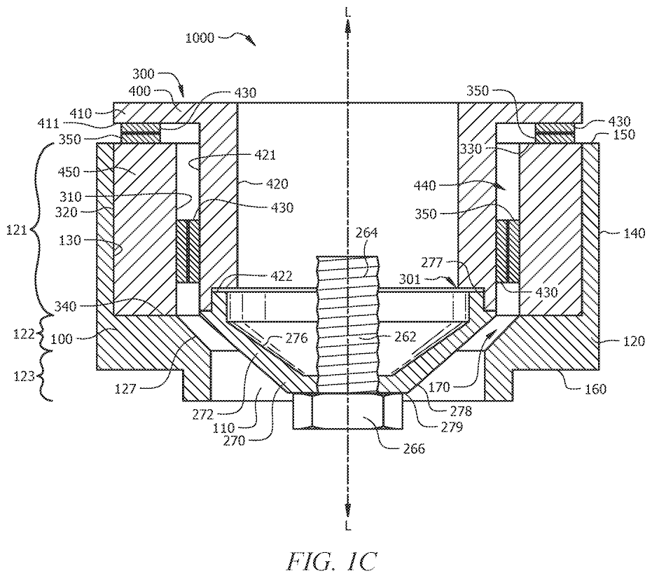

FIG. 1A illustrates a cross sectional view of a flow-through thrust and radial bearing assembly 1000. The flow-through thrust and radial bearing assembly 1000 includes a bearing holder or holder 100, a shaft fastener or a retainer 200, and a flow-through thrust and radial bearing 300. The holder 100, the shaft fastener 200, and the flow-through thrust and radial bearing 300 each share the same longitudinal axis L. While the shaft fastener 200 and the flow-through thrust and radial bearing 300 are illustrated as separate pieces/components in FIG. 1A, in some aspects, the shaft fastener 200 and the flow-through thrust and radial bearing 300 can be integrally formed as a single piece. While the holder 100 and the flow-through thrust and radial bearing 300 are illustrated as separate pieces in FIG. 1A, in some aspects, the holder 100 and the flow-through thrust and radial bearing 300 can be integrally formed as a single piece.

The holder 100 is configured to hold the flow-through thrust and radial bearing 300. Particularly, the holder 100 is configured to hold an outer race 450 of the flow-through thrust and radial bearing 300 while an inner race 400 rotates within the outer race 450. The holder 100 is additionally configured to indirectly hold the shaft fastener 200 via the outer race 450 and the inner race 400. The holder 100 has a hollow interior 110 formed in a body 120. The body 120 of the holder 100 has an inlet holding section 121, a flow-through section 122, and an outlet section 123. The body 120 has an inner surface 130, an outer surface 140, a top surface or a top 150, and a bottom surface 160. The inner surface 130 defines the contour of the inlet holding section 121, the flow-through section 122, and the outlet section 123. The inlet holding section 121 is contoured 1) to contact and hold the outer race 450 in a stationary position. The flow-through section 122 is configured to form a flow channel 170 between i) a bottom 301 of the flow-through thrust and radial bearing 300 (e.g., the bottom of the inner race 400) and an inner wall 127 of the flow-through section 122 and ii) the shaft fastener 200 and the inner wall 127 of the flow-through section 122. The outer surface 140 is configured with a contour that does not interfere with the side wall(s) of the housing of the autoclave reactor in which the flow-through thrust and radial bearing assembly 1000 is contained. The top surface 150 is configured to not interfere with the rotation of the inner race 400 relative to the outer race 450 and the holder 100. The bottom surface 160 is configured to contact the bottom of the autoclave reactor in which the flow-through thrust and radial bearing assembly 1000 is contained, and in some aspects, has a contour to fit into friction-fit position with a corresponding contour on the bottom of the autoclave reactor. The holder 100 can be formed of a solid material that is inert to the reaction environment of the autoclave reactor in which the flow-through thrust and radial bearing assembly 1000 is contained. Additional description for the holder 100 is included herein.

The flow-through thrust and radial bearing 300 can be embodied as any thrust and radial bearing. In FIG. 1A, the flow-through thrust and radial bearing 300 has the inner race 400 and the outer race 450, where each of the inner race 400 and outer race 450 has a plurality of bearing elements 350 and 430 comprising one or more superhard materials.

The inner race 400 rotates along longitudinal axis L relative to the outer race 450 and relative to the holder 100 that holds the outer race 450. The rotation of the inner race 400 is driven by a shaft of an agitator assembly of an autoclave reactor in which the flow-through thrust and radial bearing assembly 1000 is contained. The inner race 400 has a top portion 410 and a bottom portion 420 that can be integrally formed; alternatively, can be separately formed and connected via welds, threads, bolts, or combinations thereof. One or more bearing elements 430 are positioned on a bottom surface 411 of the top portion 410 of the inner race 400, and one or more bearing elements 430 are positioned on the outer surface 421 of the bottom portion 420 of the inner race 400.

The outer race 450 is stationary and configured as a stator. The outer race 450 has an annular shape that is defined by an inner surface 310, an outer surface 320, a top surface 330, and a bottom surface 340. The outer surface 320 and the bottom surface 340 are configured to contact the inner surface 130 of the holder 100. One or more bearing elements 350 are positioned on the inner surface 310 of the outer race 450, and one or more bearing elements 350 are positioned on the top surface 330 of the outer race 450.

The one or more bearing elements 430 on the bottom surface 411 of the top portion 410 of the inner race 400 face the one or more bearing elements 350 on the top surface 330 of the outer race 450. The one or more bearing elements 430 on the outer surface 421 of the bottom portion 420 of the inner race 400 face the one or more bearing elements 350 on the inner surface 310 of the outer race 450. The one or more bearing elements 430 extend from the respective surfaces such that a gap is formed between the outer race 450 and the inner race 400. The gap can have a width of about 1 mm to about 10 mm. The gap forms a flow channel 440 that fluidly connects with the first flow channel 170. The inlet to the flow channel 440 is between the bottom surface 411 of the top portion 410 of the inner race 400 and the top surface 330 of the outer race 450. The outlet to the flow channel 440 is between the outer surface 421 of the bottom portion 420 of the inner race 400 and the inner surface 310 of the outer race 450.

The flow-through of the first flow channel 170 and second flow channel 440 allows reaction medium to pass through the interior of the flow-through thrust and radial bearing assembly 1000 and through the outlet of the autoclave reactor in which the flow-through thrust and radial bearing assembly 1000 is contained. The reaction medium can absorb heat generated by the friction between the one or more bearing elements 350 of the outer race 450 and the one or more bearing elements 430 of the inner race 400.

The plurality of bearing elements 350 and 430 can be formed of a superhard material such as polycrystalline diamond, polycrystalline cubic boron nitride, silicon carbide, tungsten carbide, tantalum carbide, other carbides exhibiting a hardness at least equal to that of tungsten carbide, or combinations thereof. In some aspects, the plurality of bearing elements 350 and 430 can include, independently, a material having a Mohs hardness greater than or equal to about 9, or about 10, and can include tungsten carbide, diamond, or a combination thereof.

Each of the plurality of bearing elements 350 and 430 can have any shape, each with a bearing surface having at least a portion thereof that is flat or substantially flat or substantially planar. The one or more bearing elements 350 can be present in any number and configuration on inner surface 310 of the outer race 450, such as one or more rows forming one or more rings of the one or more bearing elements 350. The one or more bearing elements 350 can be present in any number and configuration on top surface 330 of the outer race 450, such as one or more rows forming one or more circles of the one or more bearing elements 350. The one or more bearing elements 430 can be present in any number and pattern on the outer surface 421 of the bottom portion 420 of the inner race 400, such as one or more rows forming one or more rings of the bearing elements 430. The one or more bearing elements 430 can be present in any number and pattern on the bottom surface 411 of the top portion 410 of the inner race 400, such as one or more rows forming one or more circles of the one or more bearing elements 430.

Examples of the outer race 450 with the one or more bearing elements 350 and the inner race 400 with the one or more bearing elements 430 are described for in U.S. Pat. No. 9,702,401, which is incorporated by reference in its entirety.

The shaft fastener 200 is connected to the bottom 301 of the flow-through thrust and radial bearing 300 (e.g., connected to the bottom surface 422 of the inner race 400). The shaft fastener 200 has an inner surface 230, an outer surface 240, a top surface 250, and a bottom surface 260. The inner surface 230 is contoured to contact and hold a bottom end of shaft of the agitator assembly of the autoclave reactor in which the flow-through thrust and radial bearing assembly 1000 is contained. The outer surface 240 is configured to form the first flow channel 170 between the shaft fastener 200 and the inner wall 127 of the flow-through section 122 of the body 120. The top surface 250 is configured to contact a bottom surface 422 of the inner race 400. The bottom surface 260 is spaced apart from the bottom of the autoclave reactor in which the flow-through thrust and radial bearing assembly 1000 is contained. Additional description for the shaft fastener 200 is included herein. In aspects, the shaft fastener 200 can be formed of a solid material that is inert to the reaction environment of the autoclave reactor in which the flow-through thrust and radial bearing assembly 1000 is contained.

In aspects, the shaft fastener 200 extends through the flow-through section 122 of the holder 100 and into the outlet section 123, as depicted in FIG. 1A. The first flow channel 170 extends between the outer surface 240 of the shaft fastener 200 and the inner wall 127 of the flow-through section 122 of the holder 100.

FIG. 1B illustrates a cross sectional view of another embodiment of a flow-through thrust and radial bearing assembly 2000 for an autoclave reactor. The embodiment of FIG. 1B illustrates aspects where the inner race 400 and the shaft fastener 200 are integrally formed and where the outer race 450 and the holder 100 are integrally formed. All other configurations and aspects of the flow-through thrust and radial bearing assembly 2000 as described for the flow-through thrust and radial bearing assembly 1000.

FIG. 1C illustrates a cross sectional view of yet another embodiment of a flow-through thrust and radial bearing assembly 1000 for an autoclave reactor. The flow-through thrust and radial bearing assembly 1000 includes the holder 100, another embodiment of a shaft fastener 270, a mechanical fastener 262, and the flow-through thrust and radial bearing 300. The shaft fastener 270 is connected to the bottom 301 of the flow-through thrust and radial bearing 300 with the mechanical fastener 262, such as a bolt or a rod having threads 264 and secured with a nut 266. The mechanical fastener 262 can couple or connect with a shaft within the inner race 400. The shaft fastener 270 has an inner surface 276, an outer surface 278, a top surface 277, and a bottom surface 279. The inner surface 276 is contoured to contact and hold a bottom end of shaft of the agitator assembly of the autoclave reactor in which the flow-through thrust and radial bearing assembly 1000 is contained. The outer surface 278 is configured to form the first flow channel 170 between the shaft fastener 270 and the inner wall 127 of the flow-through section 122 of the body 120, and can facilitate fluid flow in the first flow channel 170 with a contoured configuration. The top surface 277 is configured to contact a bottom surface 422 of the inner race 400. The bottom surface 279 is spaced apart from the bottom of the autoclave reactor in which the flow-through thrust and radial bearing assembly 1000 is contained. In some aspects, the inner race 400 and the shaft fastener 270 are integrally formed and where the outer race 450 and the holder 100 are integrally formed. While the shaft fastener 270 and the flow-through thrust and radial bearing 300 are illustrated as separate pieces/components in FIG. 1C, in some aspects, the shaft fastener 270 and the flow-through thrust and radial bearing 300 can be integrally formed as a single piece, as depicted in FIG. 1B. While the holder 100 and the flow-through thrust and radial bearing 300 are illustrated as separate pieces in FIG. 1C, in some aspects, the holder 100 and the flow-through thrust and radial bearing 300 can be integrally formed as a single piece.

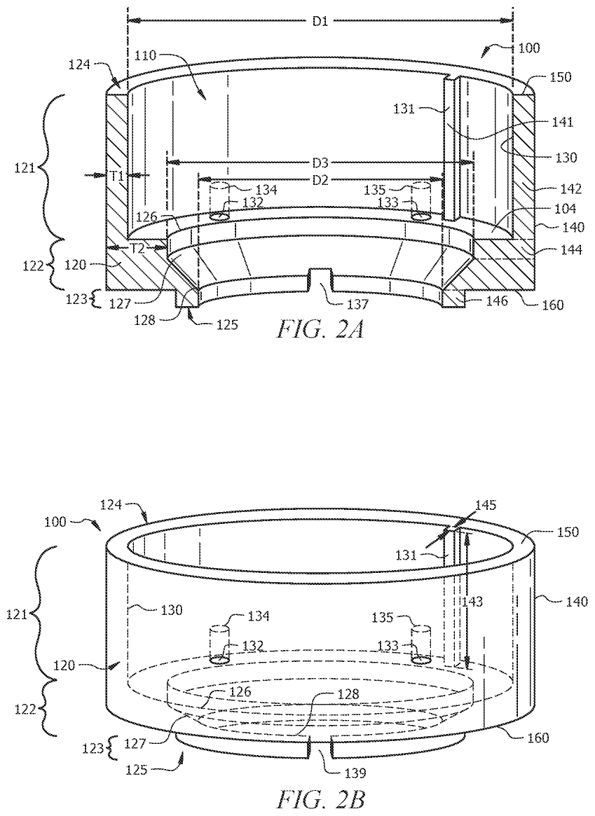

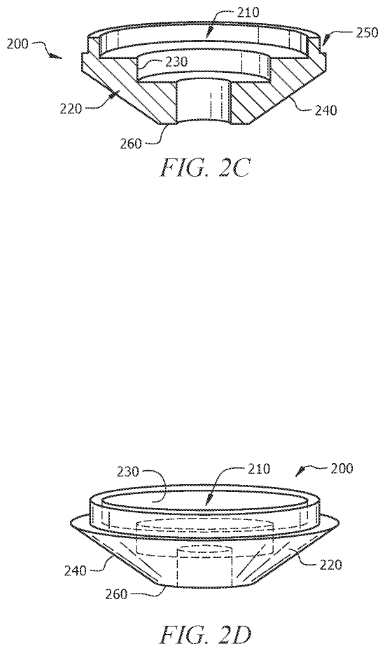

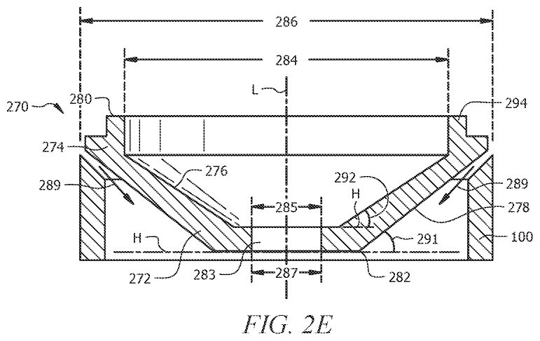

FIG. 2A illustrates an isolated cross sectional view and FIG. 2B illustrates an isolated perspective view of the holder 100 of the flow-through thrust and radial bearing assembly 1000 in FIG. 1C. The body 120 of the holder 100 has an inlet holding section 121, a flow-through section 122, and an outlet section 123. The flow-through section 122 is between the inlet holding section 121 and the outlet section 123. The inlet holding section 121 is formed in an end 124 of the holder 100 and is configured to receive and hold the outer race 450 of the flow-through thrust and radial bearing 300. The flow-through section 122 is formed in a middle of the holder 100 between the inlet holding section 121 and the outlet section 123. The flow-through section 122 has an end 126 fluidly connected to the inlet holding section 121 and has an inner wall 127 tapered to form the first flow channel 170 between the inner wall 127 and the bottom 301 of the flow-through thrust and radial bearing 300. The outlet section 123 is formed in an opposite end or a bottom 125 of the holder 100 and is fluidly connected to an opposite end 128 of the flow-through section 122.

In nonlimiting aspects, the inlet holding section 121 and the outlet section 123 can have a cylindrical shape, and the flow-through section 122 can have a frusto-conical shape. As an example, the inlet holding section 121 can be a first cylindrical ring or cylindrical shape having a radial thickness T1 stacked on or integrally formed with the flow-through section 122, which can be shaped frusto-conical including a second cylindrical ring 144 having a radial thickness T2 formed integrally with the conical inner wall 127. The radial thickness T2 of the second cylindrical ring 144 can be greater than the radial thickness T1 of the first cylindrical ring 142. In some aspects, the holder 100 includes a shelf 104 extending from an inner diameter of the first cylindrical ring 142 to an inner diameter of the second cylindrical ring 144. The shelf 104 can include one or more holes (e.g., hole 132 and hole 133) disposed or formed therein, as hereinafter described.

The flow-through section 122 can further include the conical inner wall 127 stacked on and formed integrally with the outlet section 123, which can be a third cylindrical ring 146 or cylindrical shape. Particularly, the conical inner wall 127 can be formed integrally with the third cylindrical ring 146 of the outlet section 123. Thus, an assembly of the inlet holding section 121 and the flow-through section 122 can be stacked on and formed integrally with the outlet section 123.

Moreover, the inlet holding section 121 has a diameter D1 that is greater than a diameter D2 of the outlet section 123. The end 126 of the flow-through section 122 can have a diameter D3 that is greater than a diameter D2 of the opposite end 128 of the flow-through section 122 (and the outlet section 123). The end 126 of the flow-through section 122 can have a diameter D3 that is less than a diameter D1 of the inlet holding section 121. The opposite end 128 of the flow-through section 122 can have a diameter D2 that is less than the diameter D3 of the end 126 of the flow-through section 122.

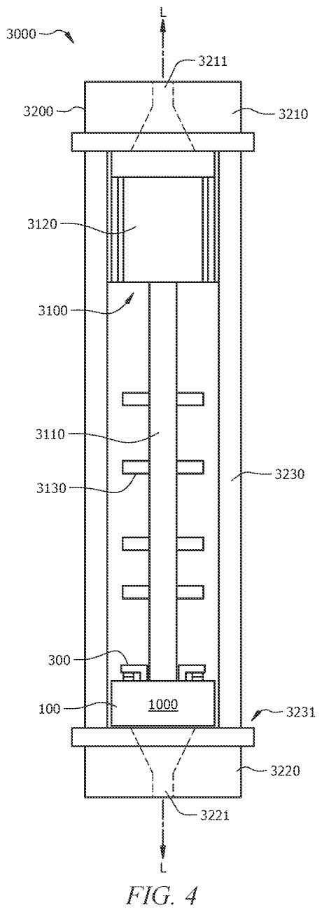

The inner surface 103 of the holder 100 can be coupled, e.g., integrally formed with a key 131. The key 131 can be a generally prism shape or a rectangular structure 141 with an axial length 143 and a radial distance 145. In some aspects, the key 131 extends radially inward from the inner surface 103 of the holder 100. In some aspects the key 131 is recessed in the inner surface 103. The second cylindrical ring 144 of the flow-through section 122 can include or form the one or more holes 132 and 133, which can be any suitable number of holes ranging from two to six, sometimes four holes. The holes 132 and 133 can receive respective pins 134 and 135. In some aspects, the pins 134 and 135 mount into a bottom 3220 of an autoclave reactor 3000 (as discussed in further detail below with respect to FIG. 4) and extend up into the holder 100 to prevent rotation. The key 131 (and corresponding keyway 456 described hereinafter), holes 132 and 133, and pins 134 and 135 can serve as an anti-rotation device to prevent the rotation of the holder 100 and the outer race 450. The anti-rotation device restricts movement of the holder 100 and outer race 450 relative to one another during operation.

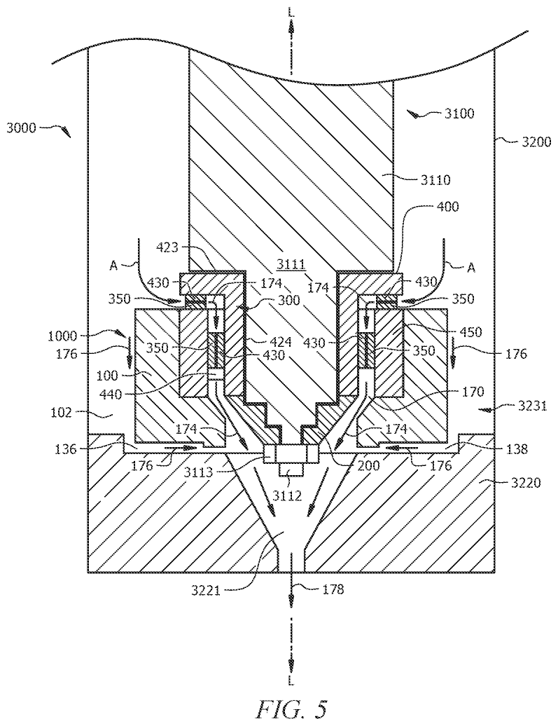

The holder 100 can include flow passageways formed in the outlet section 123 of the holder 100. Any suitable number of flow passageways may be formed in the holder 100, such as one, two, three, four, five, six, or more. In some aspects, four flow passageways namely a first flow passageway 136 (depicted in FIG. 5), a second flow passageway 137 (depicted in FIG. 2A), a third flow passageway 138 (depicted in FIG. 5), and a fourth flow passageway 139 (depicted in FIG. 2B) may be disposed around the outlet section 123 in the holder 100. In some aspects, the passageways are equidistant from one another. The flow passageways allow the regulation of fluid flow through an autoclave reactor for controlling temperature, as discussed hereinafter.

In some alternative aspects, no holes or passages (e.g., flow passageways) or flow channels are formed in the body 120 of the holder 100. Put another way, the body 120 of the holder 100 is free of apertures of any form.

FIG. 2C illustrates an isolated cross sectional view and FIG. 2D illustrates an isolated perspective view of the shaft fastener 200 of the flow-through thrust and radial bearing assembly 1000. The shaft fastener 200 has a hollow interior 210 formed in a body 220 and that is shaped to match the dimensions of the end of a shaft of the agitator assembly. The inner surface 230 defines the contour of the hollow interior 210. The hollow interior 210 is entirely filled with the end of the shaft when in use. The top surface 250 can be contoured to match the bottom surface 422 of the inner race 400.

FIG. 2E illustrates an isolated cross sectional view of another embodiment of a shaft fastener or a retainer 270 of the flow-through thrust and radial bearing assembly 1000. In some aspects, the shaft fastener 270 can include a body 272 having a generally frusto-conical shape 274 and having an inner surface 276 and an outer surface 278. In this view, the mechanical fastener 262, as discussed above, is omitted. The shaft fastener 270 and the holder 100 can at least in part define a conduit for a fluid flow 289. The inner surface 276 defines a first diameter 284 perpendicular to a longitudinal axis L and defines a second diameter 285 perpendicular to the longitudinal axis L of an opening 283. Generally, the first diameter 284 is spaced apart axially from the second diameter 285. In aspects, the outer surface 278 has a first diameter 286 perpendicular to the longitudinal axis L and defines a second diameter 287 of the opening 283. The second diameter 287 can be perpendicular to the longitudinal axis L. Generally, the first diameter 286 is spaced apart axially from the second diameter 287. In some aspects, the inner surface 276 forms a lip 294 for engaging and securing the shaft fastener 270.

The opening 283 can take a variety of shapes. In some aspects, the second diameter 285 defined by the inner surface 276 and the second diameter 287 defined by the outer surface 278 are substantially equal forming the opening 283 having a generally cylindrical curved surface. In some aspects, the second diameter 285 of the inner surface 276 has a lesser diameter than the second diameter 287 of the outer surface 278 forming the opening 283 having a substantially truncated conical shape. In aspects, the second diameter 285 of the inner surface 276 has a greater diameter than the second diameter 287 of the outer surface 278 forming the opening 283 having a substantially inverse truncated conical shape.

The inner surface 276 and the outer surface 278 can be orientated in a variety of positions relative to one another. In some aspects, the inner surface 276 and the outer surface 278 skew in an axial direction from the first diameter 284 to the second diameter 287. Particularly, the inner surface 276 and the outer surface 278 can diverge or converge in an axial direction from the first diameter 284 to the second diameter 287. Alternatively in some aspects, the inner surface 276 and the outer surface 278 are generally parallel in an axial direction from the first diameter 284 to the second diameter 287.

In some aspects, a shaft fastener 270 for an autoclave reactor includes the body 272 having the generally frusto-conical shape 274. The body 272 can include the inner surface 276 and the outer surface 278 and the inner surface 276 and the outer surface 278 skew, e.g., diverge or converge, in a general direction of the fluid flow 289 exiting the autoclave reactor 3000.

In some aspects, the shaft fastener 270 has an end 280 and an opposite end 282, and the end 280 has the first diameter 286 and the opposite end 282 defines the second diameter 287. In aspects, the opposite end 282 forms the opening 283 defined by the second diameter 287, and the opening 283 is defined as a generally cylindrical curved surface, substantially truncated conical, or substantially inverse truncated conical.

In some aspects, the outer surface 278 forms an angle 291 with respect to horizontal H greater than an angle 292 of the inner surface 276 defined with respect to horizontal H. The outer surface 278 forms the angle 291 with respect to horizontal H of about 38 degrees to about 42 degrees, about 39 degrees to about 41 degrees, or about 40 degrees, and the inner surface 276 forms the angle 292 with respect to horizontal H of about 28 degrees to about 32 degrees, about 29 degrees to about 31 degrees, or about 30 degrees. In some further aspects, the outer surface 278 forms the angle 291 with respect to horizontal H lesser than the angle 292 of the inner surface 276 defined with respect to horizontal H. As an example, the outer surface 278 forms the angle 291 with respect to horizontal H of about 28 degrees to about 32 degrees, about 29 degrees to about 31 degrees, or about 30 degrees, and the inner surface 276 forms the angle 292 with respect to horizontal H of about 38 degrees to about 42 degrees, about 39 degrees to about 41 degrees, or about 40 degrees. The shaft fastener 270 can form the lip 294 at the end 280 for engaging and securing the shaft fastener 270.

In a further aspect, a shaft fastener 270 for the autoclave reactor can include the body 272 having the generally frusto-conical shape 274. The body 272 can include the inner surface 276 and the outer surface 278, and the inner surface 276 and the outer surface 278 are generally parallel in the general direction of a fluid flow 289 exiting the autoclave reactor 3000.

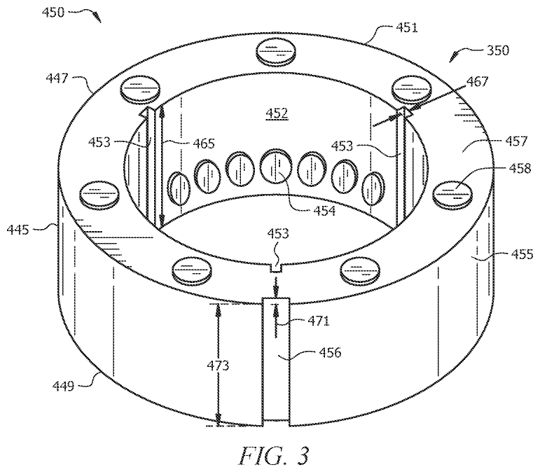

FIG. 3 illustrates an isolated perspective view of the outer race 450. The outer race 450 of the one or more bearing elements 350 for the autoclave reactor can include a body 445 having a generally annulus shape 451, e.g., a cylinder or a cylindrical shape, a top 447, a bottom 449, an inner surface 452, an outer surface 455, and a top surface 457. The inner (cylindrical) surface 452 can include (e.g., forming) one or more conduits 453, e.g., one or more rectangular grooves extending a radial depth 467 into the inner surface 452 and extending an axial length 465 from the top 447 to the bottom 449. In aspects, the one or more conduits 453 includes three conduits 453. Particularly, the dimensions and number of conduits 453 can be based on a predetermined fluid flow ratio through the plurality of bearing elements 350 and 430 versus bypassing some of the fluid flow through these elements 350 and 430. The dimension and number of conduits 453 may also depend on the viscosity properties of the reaction medium in the presence of the shear applied within the annular region, rotation speeds and their adjustment, modifications to the annular space that effects material flow, and other variables.

In aspects, one or more radial bearing elements 454 coupled to the inner surface 452, and one or more thrust bearing elements 458 coupled to the top surface 457.

In some aspects, the one or more radial bearing elements 454, e.g., cylindrical buttons or nubs, and one or more thrust bearing elements 458, e.g., cylindrical buttons or nubs, can include, independently, a material having a Mohs hardness greater than or equal to about 9. Generally, the one or more radial bearing elements 454 and one or more thrust bearing elements 458 include tungsten carbide, diamond, or a combination thereof.

As part of the anti-rotation device, the outer surface 455 can include, e.g., forming, the keyway 456, e.g., one or more axial rectangular grooves or slots extending a radial depth 471 into the outer surface 455 and extending an axial length 473 from the top 447 to the bottom 449. The keyway 456 can receive the key 131 of the holder 100 to prevent rotation of the outer race 450, and thus comprising a portion of the anti-rotation device.

FIG. 4 illustrates a side view of the inside of the autoclave reactor 3000, showing the flow-through thrust and radial bearing assembly 1000 attached to the bottom of an agitator assembly 3100 in the bottom of the autoclave reactor 3000.

The autoclave reactor 3000 can include a housing 3200 having a top 3210, the bottom 3220, and a vessel body 3230 connected between the top 3210 and the bottom 3220. The housing 3200 can include an inlet 3211 (also referred to as reactor inlet) formed in the top 3210 and an outlet 3221 (also referred to as reactor outlet) formed in the bottom 3220. Other inlets can be included, such as inlets formed in the vessel body 3230 on the side of the autoclave reactor 3000.

The housing 3200 receives reaction components into an interior of the housing 3200 via the inlet 3211. The reaction components react in the housing 3200 to form a polymer product in a reaction medium comprising a monomer, a comonomer, a diluent, a catalyst (e.g., catalyst system comprising catalyst and co-catalyst), and the polymer product (e.g., LDPE). The reaction medium moves from the top 3210 to the bottom 3220 of the housing 3200 while being circulated and/or agitated by a rotation of the shaft 3110 of the agitator assembly 3100.

The agitator assembly 3100 can be contained within the housing 3200 for agitating or stirring the reaction medium within the interior of the housing 3200. The agitator assembly 3100 can include the shaft 3110 and a motor 3120 coupled to the shaft 3110, for rotating the shaft 3110. Any suitable motor can be used. The agitator assembly 3100 can also include one or more paddles 3130, each of which extends radially outwardly from the shaft 3110 to provide additional surface area for moving, mixing, and agitating the reaction medium within the housing 3200. In some embodiments, for internal motors, there is a physical barrier between the motor 3120 and a reaction zone to prevent reaction products from entering the motor 3120. The physical barrier can include a sealing plate on a bottom of a weight block that can reside on a ledge in the autoclave reactor 3000 between a motor chamber and a main reaction volume. A middle of a block and plate is bored that can receive an agitator shaft 3110 to pass there-through so the motor 3120 can be coupled to the agitator assembly 3100.

In aspects, the motor 3120 is free-floating in the housing 3200, in that, the agitator assembly 3100 (e.g., the motor 3120) is not connected to the top 3210 of the housing 3200, is not connected to the vessel body 3230 of the housing 3200, or is not connected to both the top 3210 and the vessel body 3230 of the housing 3200. In these aspects, the flow-through thrust and radial bearing assembly 1000 supports the entire weight of the agitator assembly 3100.

Alternatively, the agitator assembly 3100 (e.g., the motor 3120 or a top end of the shaft 3110 that extends above the motor 3120) can be connected (e.g., via other bearings or another flow-through thrust and radial bearing assembly 1000) to the top 3210 of the housing 3200, to the vessel body 3230 of the housing 3200, or to both the top 3210 and the vessel body 3230 of the housing 3200. In these aspects, the flow-through thrust and radial bearing assembly 1000 supports less than all the weight of the agitator assembly 3100.

The flow-through thrust and radial bearing assembly 1000 is shown on the bottom 3231 of the vessel body 3230, resting on the bottom 3220 of the housing 3200. The holder 100 can be seen on the bottom 3220 of the housing 3200 and holding the flow-through thrust and radial bearing 300. The holder 100 is supporting or coupled to the flow-through thrust and radial bearing 300, which is connected to a bottom end of the shaft 3110. The shaft 3110 of the agitator assembly 3100 can be seen extending into the flow-through thrust and radial bearing 300 of the flow-through thrust and radial bearing assembly 1000. The motor 3120 causes the shaft 3110 to rotate along the longitudinal axis L of the autoclave reactor 3000, which is also the longitudinal axis for the flow-through thrust and radial bearing assembly 1000.

In aspects, the outlet section 123 of the holder 100 (e.g., outlet section 123 as depicted in FIGS. 1A, 1B, 2A, and 2B) is fluidly connected to the outlet 3221 of the housing 3200 of the autoclave reactor 3000 (e.g., FIG. 5).

The autoclave reactor 3000 can be used to produce low density polyethylene (LDPE). As such, the material introduced to the reactor can be ethylene. The autoclave reactor 3000 can also be used to produce LDPE copolymers, which can be or can include one or more copolymers, including terpolymers, having ethylene-derived monomer units and at least one other olefin-derived monomer units. The materials introduced to the autoclave reactor 3000 thus can include ethylene and at least one other comonomer.

Examples of suitable comonomers include C₃-C₂₀ olefins; alternatively, C₃-C₁₂ olefins. The comonomer can be linear or branched, and two or more comonomers can be used. Examples of suitable comonomers include linear C₃-C₁₂ olefins and olefins having one or more C₁-C₃ alkyl branches or an aryl group. Specific examples include but are not limited to propylene; 1-butene; 3-methyl-1-butene; 3,3-dimethyl-1-butene; 1-pentene; 1-pentene with one or more methyl, ethyl, or propyl substituents; 1-hexene with one or more methyl, ethyl, or propyl substituents; 1-heptene with one or more methyl, ethyl, or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; styrene, or combinations thereof. Examples of suitable polar comonomers can include vinyl acetate, methyl acrylate, and butyl acrylate.

The LDPE polymer or copolymer can be produced using a high pressure and high temperature polymerization process. Various process variations that achieve safe and economical operating conditions are known in the art. By way of example, the polymerization process of ethylene can be performed at a pressure of about 1,310 bar to about 3,100 bar and a temperature of about 148° C. to about 310° C. when a single autoclave reactor is used.

The polymerization reaction can be enhanced or initiated by the injection of at least one initiator or solvent. Suitable initiators can be or can include one or more organic peroxides, such as t-butylperoxy neodecanoate together with t-butylperoxy 2-ethylhexanoate, t-butylperoxy perbenzoate, or di(t-butyl)peroxide. Suitable solvents can be or can include one or more linear or branched C₄ to C₇ alkanes. Particularly preferred solvents include butane, pentane, hexane, iso-butane, iso-pentane, iso-hexane, or mixtures thereof.

The LDPE polymer or copolymer process can take place in a single autoclave reactor, a multi-chamber autoclave reactor, or a cascade of autoclave reactors arranged in parallel or series, depending on the desirable product slate. The autoclave reactor(s) can include a thick-walled forged or two-layer shrunk cylindrical housing. The ratio of inside length to inner diameter can range from about one to about two. The autoclave reactor(s) can be equipped with an agitator driven by an external or internal electric motor, with an internal motor being preferred. The agitator desirably provides good mixing of the ethylene, the initiator, if any, and the comonomer. Preferably, the agitator achieves high turbulence near the inside wall to avoid polymer deposition.

The residence time in a single autoclave reactor 3000 can range from about 15 to about 60 seconds. The reactor can be operated adiabatically such that the heat of reaction is removed by the fresh ethylene entering the reactor. In some aspects, a reaction medium can include unreacted reactants such as monomers or comonomers, one or more catalysts, one or more reaction products such as LDPE, one or inert compounds or diluents, or combinations thereof. The conversion rate is related, therefore, to the difference in temperature between the feed and the reactor temperature. The main feature of the LDPE polymer or copolymer produced from a single autoclave process is a broader molecular-weight distribution, which gives excellent properties for shrink-films and heavy duty packaging.

The LDPE polymer or copolymer process can be improved when more than one of autoclave reactor 3000 are arranged in series. By feeding fresh ethylene into the line between the reactors and/or removing heat by means of coolers, the conversion rate can be increased. When initiators of different activity are used in the different reactors, the reactors can be run at different temperatures. Also, the split of the feed of fresh ethylene can be varied. Compared to the single reactor process, the cascade arrangement gives more flexibility to adjust the properties of LDPE polymer or copolymer.

Higher conversion rates can be achieved in a multi-zone or autoclave reactor. The multi-zone reactor can include an elongated cylindrical housing having a ratio of length to inner diameter of about 10 to about 12. The reactor can be subdivided by baffles, and the agitator can extend through two or more chambers, e.g., two to five chambers. The chambers can have different volumes, with the top chamber being the largest. For example, the top chamber can make up 30% to 50% of the total volume. Each chamber can be equipped with thermocouples and feed lines for fresh ethylene, comonomer, if any, and initiator, if any.

The multi-zone autoclave reactor can be operated with a temperature profile. The temperature in the top chamber can be moderately high, e.g., in the range of about 165° C. to about 200° C. The temperature in the bottom zone can be even higher, e.g., in the range of about 280° C. to about 310° C., to adjust the density of the polymer. Through the temperature profile, which is controlled by the initiator feed and the split of fresh ethylene, the properties of the polymers can be varied. Different peroxides can be used as initiators when the zones are operated at different temperatures.

FIG. 5 illustrates a cross sectional isolated view of the flow-through thrust and radial bearing assembly 1000 in the bottom 3231 of the autoclave reactor 3000. In some aspects, a bottom end 3111 of the shaft 3110 of the agitator assembly 3100 can be seen inserted into the inner race 400 of the flow-through thrust and radial bearing 300 and in contact with a top surface 423 and an inner surface 424 of the inner race 400. The bottom end 3111 of the shaft 3110 of the agitator assembly 3100 is also in contact with the inner surface 230 (as depicted in, e.g., FIG. 2D) of the shaft fastener 200. A threaded element 3112 extends through the shaft fastener 200 such that a nut 3113 secures the bottom end 3111 of the shaft 3110 to the shaft fastener 200 via the threaded element 3112. While threaded element 3112 and nut 3113 are illustrated, other securing elements and techniques can be used to connect the bottom end 3111 of the shaft 3110 to the shaft fastener 200. The shaft fastener 200 functions as an adapter to connect the bottom end 3111 of the shaft 3110 to the inner race 400 of the flow-through thrust and radial bearing 300. The shaft 3110, the shaft fastener 200, and the inner race 400 of the flow-through thrust and radial bearing 300 rotate together in response to the rotation imparted onto the shaft 3110 by the motor 3120 (as depicted in, e.g., FIG. 4) of the agitator assembly 3100.

The reaction medium flows into and through the second flow channel 440 of the flow-through thrust and radial bearing assembly 1000, as well as out of the flow-through thrust and radial bearing assembly 1000 into the first flow channel 170, to the outlet 3221 of the autoclave reactor 3000, in the direction of arrows A.

Rotation of the inner race 400 relative to the outer race 450 creates heat between the one or more bearing elements 350 and one or more bearing elements 430 of the flow-through thrust and radial bearing assembly 1000. An advantage of the flow-through thrust and radial bearing assembly 1000 disclosed herein is that the flow of reaction medium through the flow-through thrust and radial bearing assembly 1000 provides cooling to the bearing elements of the flow-through thrust and radial bearing assembly 1000. Thus, a separate coolant for the plurality of bearing elements 350 and 430 is not needed.

Particularly, the agitator assembly 3100 can be supported by (e.g., coupled to) the flow-through thrust and radial bearing assembly 1000 that is positioned in the housing 3200 of the autoclave reactor 3000. In some aspects, the reaction medium and the LDPE can be removed from the autoclave reactor 3000 via the first flow channel 170 and an annular passage 102. Specifically, a first part or portion 174 of the reaction medium and the LDPE can pass through the second flow channel 440 and the first flow channel 170, and a second part/portion 176 of the reaction medium and the LDPE can pass through an annular passage 102 formed outside the holder 100 and inside the housing 3200. The first flow channel 170 is formed between the inner race 400 and a holder 100 of the flow-through thrust and radial bearing assembly 1000 to pass the first part or portion 174 past the plurality of bearing elements 350 and 430, and the annular passage 102 is formed outside the holder 100 and inside the housing 3200. In aspects, the annular passage 102 communicates with a flow passageway 136, 137, 138, or 139 underneath at least a portion of the holder 100 and the outer race 450 to pass the second part/portion 176 of the reaction medium and the LDPE from the autoclave reactor 3000 for controlling a temperature of a component of the autoclave reactor 3000 (e.g., the flow-through thrust and radial bearing assembly 1000) by passing the first part or portion 174 through the plurality of bearing elements 350 and 430 for preventing over-polymerization and degradation of the LDPE. The first part or portion 174 and the second part or portion 176 can combine to a total volume flow rate 178 exiting the autoclave reactor 3000.

In aspects, the bypass of the second part or portion 176 in the annular passage 102 can control the temperature of the flow-through thrust and radial bearing assembly 1000 to maintain temperatures in the desired reaction range. Additionally, passing the first part or portion 174 through the plurality of bearing elements 350 and 430 can provide sufficient heat removal to cool the autoclave reactor 3000 and prevent over-polymerization and build-up of scale and other undesirable byproducts. The plurality of bearing elements 350 and 430 can be subject to excessive heat and passing the first part or portion 174 can cool these parts and prevent unwanted side reactions and over-polymerization due to excessive temperature in the autoclave reactor 3000. If the first part or portion 174 provides too much cooling, some of the first part or portion 174 can be routed to the second part or portion 176 and be passed through the annular passage 102 bypassing the plurality of bearing elements 350 and 430. This prevention of undesired byproducts due to over-polymerization can reduce maintenance requirements of the autoclave reactor 3000.

For controlling the autoclave reactor 3000 temperature in some aspects, the first part or portion 174 and second part or portion 176 can have a combined total volume flow rate 178 through the autoclave reactor 3000, and a volume flow rate of the first part/portion 174 is at least about 10%, about 15%, about 20%, about 25%, about 30%, about 35%, about 40%, or about 45%, by volume flow rate, of the total volume flow rate 178. In aspects, the volume flow rate of the first part or portion 174 is less than or equal to about 50%, about 45%, about 40%, about 35%, about 30%, about 25%, about 20%, or about 15%, by volume flow rate, of the total volume flow rate 178. In aspects, the volume flow rate of the first part 174 is about 20% to about 40%, about 20% to about 25%, about 25% to about 30%, about 30% to about 35%, or about 35% to about 40%, by volume flow rate, of the total volume flow rate 178. In some aspects, a predetermined percentage of volume flow rate of the first part or portion 174 is controlled by selecting the dimensions and number of conduits 453 formed in the outer race. In some aspects, a predetermined percentage of volume flow rate of the first part or portion 174 is controlled by selecting the dimensions, number, and spacing of the elements 454.

A process disclosed herein can include mixing, with the agitator assembly 3100 contained in the housing 3200 of the autoclave reactor 3000, a reaction medium (e.g., containing a polymer product such as LDPE) in the autoclave reactor 3000, wherein a bottom of the agitator assembly 3100 is coupled to the flow-through thrust and radial bearing assembly 1000 that is positioned on the bottom 3220 of the housing 3200 of the autoclave reactor 3000. The process can also include removing the reaction medium from the autoclave reactor 3000 via the first flow channel 170 formed between the inner race 400 and the holder 100 of the flow-through thrust and radial bearing assembly 1000 and a second flow channel 440 formed between the inner race 400 and the outer race 450 of the flow-through thrust and radial bearing assembly 1000.

### Additional Description

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the detailed description of the present disclosure. The disclosures of all patents, patent applications, and publications cited herein are hereby incorporated by reference.

Aspects of a holder for a flow-through thrust and radial bearing, a for a flow-through thrust and radial bearing assembly, an autoclave reactor, and a process have been described. The following are non-limiting, specific aspects in accordance with the present disclosure:

Aspect 1. A holder 100 for a flow-through thrust and radial bearing 300 comprising an outer race 450 and an inner race 400, wherein each of the outer race 450 and the inner race 400 has a plurality of bearing elements 350 and 430 comprising one or more superhard materials, the holder 100 comprising: an inlet holding section 121, a flow-through section 122, and an outlet section 123; wherein the inlet holding section 121 is formed in an end 124 of the holder 100 and is configured to receive and hold the outer race 450 of the flow-through thrust and radial bearing 300; wherein the flow-through section 122 is formed in a middle of the holder 100 between the inlet holding section 121 and the outlet section 123, wherein the flow-through section 122 has an end 126 fluidly connected to the inlet holding section 121 and has an inner wall 127 tapered to form a flow channel 170 between the inner wall 127 and a bottom 301 of the flow-through thrust and radial bearing 300; and wherein the outlet section 123 is formed in an opposite end 125 of the holder 100 and is fluidly connected to an opposite end 128 of the flow-through section 122.

Aspect 2. The holder 100 of Aspect 1, wherein a diameter D1 of the inlet holding section 121 is greater than a diameter D2 of the outlet section 123.

Aspect 3. The holder 100 of Aspect 1 or 2, wherein the end of the flow-through section 122 has a diameter D3 that is less than a diameter D1 of the inlet holding section 121.

Aspect 4. The holder 100 of any of Aspects 1 to 3, wherein the opposite end 128 of the flow-through section 122 has a diameter D2 that is less than the diameter D3 of the end 126 of the flow-through section 122.

Aspect 5. The holder 100 of any of Aspects 1 to 4, wherein the inlet holding section 121 has a cylindrical shape, wherein the flow-through section 122 has a conical shape, and wherein the outlet section 123 has a cylindrical shape.

Aspect 6. The holder of any of Aspects 1 to 5, wherein no holes or passages or flow channels are formed in a body 120 of the holder 100.

Aspect 7. A flow-through thrust and radial bearing assembly 1000 comprising: a flow-through thrust and radial bearing 300 comprising an outer race 450 and an inner race 400, wherein each of the outer race 450 and the inner race 400 has a plurality of bearing elements 350 and 430 comprising one or more superhard materials; and a holder 100 for the flow-through thrust and radial bearing 300, wherein the holder 100 comprises: an inlet holding section 121 formed in an end 124 of the holder 100, wherein the inlet holding section 121 is configured to receive and hold the outer race 450 of the flow-through thrust and radial bearing 300; a flow-through section 122 formed in a middle of the holder 100, wherein the flow-through section 122 has an end 126 fluidly connected to the inlet holding section 121 and has an inner wall 127 tapered to form a first flow channel 170 between the inner wall 127 and a bottom of the inner race 400 of the flow-through thrust and radial bearing 300; and an outlet section 123 fluidly connected to an opposite end 128 of the flow-through section 122.

Aspect 8. The flow-through thrust and radial bearing assembly 1000 of Aspect 7, wherein a second flow channel 440 is formed between the outer race 450 and the inner race 400, wherein the second flow channel 440 is fluidly connected to the first flow channel 170.

Aspect 9. The flow-through thrust and radial bearing assembly 1000 of Aspect 7 or claim 8, wherein the first flow channel 170 is fluidly connected to the outlet section 123.

Aspect 10. The flow-through thrust and radial bearing assembly 1000 of any of Aspects 7 to 9, wherein the one or more superhard materials comprises polycrystalline diamond, polycrystalline cubic boron nitride, silicon carbide, tungsten carbide, tantalum carbide, other carbides exhibiting a hardness at least equal to that of tungsten carbide, or combinations thereof.

Aspect 11. The flow-through thrust and radial bearing assembly 1000 of any of Aspects 7 to 10, further comprising: a shaft fastener 200 connected to a bottom of the inner race 400.

Aspect 12. The flow-through thrust and radial bearing assembly 1000 of Aspect 11, wherein the shaft fastener 200 extends through the flow-through section 122 of the holder 100 and into the outlet section 123.

Aspect 13. The flow-through thrust and radial bearing assembly 1000 of Aspect 11 or 12, wherein the first flow channel 170 extends between an outer surface 240 of the shaft fastener 200 and the inner wall 127 of the flow-through section 122 of the holder 100.

Aspect 14. An autoclave reactor 3000 comprising: a housing 3200 having a top 3210, a bottom 3220, and a vessel body 3230 connected between the top 3210 and the bottom 3230; an agitator assembly 3100 contained within the housing 3200, wherein the agitator assembly 3200 comprises a motor 3120 and a shaft 3110 coupled to the motor 3120; a flow-through thrust and radial bearing 300 connected to a bottom end 3111 of the shaft 3110, wherein the flow-through thrust and radial bearing 300 comprises an outer race 450 and an inner race 400, wherein each of the outer race 450 and the inner race 400 has a plurality of bearing elements 350 and 430 comprising one or more superhard materials; and a holder 100 positioned on a bottom 3220 of the housing 3200, wherein the holder 100 comprises: an inlet holding section 121 formed in an end 125 of the holder 100, wherein the inlet holding section 121 is configured to receive and hold the outer race 450 of the flow-through thrust and radial bearing 300; a flow-through section 122 formed in a middle of the holder 100, wherein the flow-through section 122 has an end 126 fluidly connected to the inlet holding section 121 and has an inner wall 127 tapered to form a first flow channel 170 between the inner wall 127 and a bottom of the inner race 400 of the flow-through thrust and radial bearing 300; and an outlet section 123 fluidly connected to an opposite end 128 of the flow-through section 122.

Aspect 15. The autoclave reactor 3000 of Aspect 14, wherein the bottom 3220 of the housing 3200 comprises a reactor outlet 3221, wherein the outlet section 123 of the holder 100 is fluidly connected to the reactor outlet 3221.

Aspect 16. The autoclave reactor 3000 of Aspect 14 or 15, wherein the motor 3120 is free-floating in the housing 3200.

Aspect 17. The autoclave reactor 3000 of any of Aspects 14 to 16, wherein the agitator assembly 3100 is not connected to the top 3210 of the housing 3200.

Aspect 18. The autoclave reactor 3000 of any of Aspects 14 to 16, wherein the agitator assembly 3100 is connected to the top 3210 of the housing 3200.

Aspect 19. A process for making low density polyethylene (LDPE), comprising: mixing, with an agitator assembly 3100 contained in a housing 3200 of an autoclave reactor 3000, a reaction medium to form the LDPE in the autoclave reactor 3000, wherein a bottom of the agitator assembly 3100 is coupled to a flow-through thrust and radial bearing assembly 1000 that is positioned on a bottom 3220 of the housing 3200 of the autoclave reactor 3000; and removing the reaction medium and the LDPE from the autoclave reactor 3000 via a first flow channel 170 formed between an inner race 400 and a holder 100 of the flow-through thrust and radial bearing assembly 1000 and a second flow channel 440 formed between the inner race 400 and an outer race 450 of the flow-through thrust and radial bearing assembly 1000.

Aspect 20. The process of Aspect 19, wherein each of the outer race 450 and the inner race 400 has a plurality of bearing elements 350 and 430 comprising one or more superhard materials.

Aspect 21. The process of Aspect 20, wherein the one or more superhard materials comprises polycrystalline diamond, polycrystalline cubic boron nitride, silicon carbide, tungsten carbide, tantalum carbide, other carbides exhibiting a hardness at least equal to that of tungsten carbide, or combinations thereof.

Aspect 22. The process of any of Aspects 19 to 21, wherein the agitator assembly 3100 comprises a motor 3120 that is free-floating in the housing 3200.

Aspect 23. The process of any of Aspects 19 to 22, wherein the agitator assembly 3100 is not connected to a top 3210 of the housing 3200.

Aspect 24. The process of any of Aspects 19 to 21, wherein the agitator assembly 3100 is connected to a top 3210 of the housing 3200.

Aspect 25. The process of any of Aspects 19 to 24, wherein ethylene is polymerized at a pressure in a range of from about 1,310 bar to about 3,100 bar and a temperature in a range of from about 148° C. to about 310° C.

Aspect 26. The process of claim any of Aspects 19 to 25, wherein the reaction medium comprises ethylene, a comonomer, a diluent, a catalyst, or combinations thereof.

Aspect 27. An autoclave reactor 3000 comprising: a housing 3200; an agitator assembly 3100 contained within the housing 3200, wherein the agitator assembly 3100 comprises a motor 3120 and a shaft 3110 coupled to the motor 3120; a flow-through thrust and radial bearing 300 positioned adjacent (e.g., coupled to) a bottom end 3111 of the shaft 3110, wherein the flow-through thrust and radial bearing 300 comprises the outer race 450 and an inner race 400, wherein each of the outer race 450 and the inner race 400 has a plurality of bearing elements 350 and 430 comprising one or more superhard materials; and a holder 100 supporting (e.g., coupled to) the flow-through thrust and radial bearing 300, wherein the holder 100 comprises: an inlet holding section 121 formed adjacent (e.g., in or within) an end 124 of the holder 100, wherein the inlet holding section 121 is configured to receive and hold the outer race 450 of the flow-through thrust and radial bearing 300; a flow-through section 122 formed adjacent (e.g., in or within) a middle of the holder 100, wherein the flow-through section 122 has the end 126 fluidly connected to the inlet holding section 121 and has an inner wall 127 tapered to form a first flow channel 170 between the inner wall 127 and the bottom 301 of the inner race 400 of the flow-through thrust and radial bearing 300; and an outlet section 123 fluidly connected to an opposite end 128 of the flow-through section 122, wherein the holder 100 and the housing 3200 form an annular passage 102, and the first flow channel 170 and the annular passage 102 are configured to receive fluid from inside the autoclave reactor 3000 (e.g., a reaction medium comprising unreacted reactants such as monomers or comonomers, one or more catalysts, one or more reaction products such as LDPE, one or inert compounds or diluents, or combinations thereof) for cooling at least a portion of the autoclave reactor 3000 (e.g., cooling the flow-through thrust and radial bearing 300).

Aspect 28. The autoclave reactor 3000 of Aspect 27, wherein the outer race 450 comprises (e.g., forms) an inner surface 452, and the inner surface 452 comprises (e.g., forms) one or more conduits 453 (e.g., axial grooves or flowpaths within the inner surface 452 and extending an axial length 465 thereof).

Aspect 29. The autoclave reactor 3000 of Aspect 27 or 28, wherein the outer race 450 comprises (e.g., forms) an outer surface 455, and the outer surface 455 comprises (e.g., forms) at least one keyway 456 (e.g., an axial groove or slot within the outer surface 455 and extending an axial length 473 thereof).

Aspect 30. The autoclave reactor 3000 of any of Aspects 27 to 29, wherein the holder 100 comprises a body 120 having (e.g., forming) an inner surface 130 and a key 131 coupled to the inner surface 130.

Aspect 31. The autoclave reactor 3000 of any of Aspects 27 to 30, wherein the key 131 is integrally formed with the inner surface 130 (e.g., wherein the key 131 comprises a rectangular structure 141 extending an axial length 143 of inner surface 130 and extending inward a radial distance 145 from the inner surface 130).

Aspect 32. The autoclave reactor 3000 of any of Aspects 27 to 31, wherein the key 131 has a generally prism shape 141 and size corresponding to the at least one keyway 456 formed in the outer race 450 to secure thereof such that the key 131 may be received within the at least one keyway 456.

Aspect 33. The autoclave reactor 3000 of any of Aspects 27 to 32, wherein the holder 100 comprises a flow-through section 122 comprising an end 126 (e.g., lip, edge or surface), wherein the end 126 comprises (e.g., forms) one or more holes 132, 133 for receiving one or more pins 134, 135 for securing the holder 100 in the housing 3200 to prevent rotation.

Aspect 34. The autoclave reactor 3000 of any of Aspects 27 to 33, wherein the holder 100 forms one or more flow passages 136, 137, 138, 139 configured for fluid communication with the annular passage 102.

Aspect 35. The autoclave reactor 3000 of any of Aspects 27 to 34, wherein a shaft fastener 270 is secured to the shaft 3110 with a mechanical fastener 262 (e.g., a bolt or a threaded rod and a nut).

Aspect 36. A holder 100 for an autoclave reactor 3000, alone or in combination with any of Aspects 27 to 35, comprising: a generally cylindrical upper inlet holding section 121 adjacent a top 150 of the holder 100 having a cross-sectional thickness T1; a generally cylindrical lower outlet section 123 adjacent the bottom 125 of the holder 100; and a generally frusto-conical flow-through section 122 disposed between the upper inlet holding section 121 and the lower outlet section 123 and having a cross-sectional thickness T2, wherein T2 is greater than T1 and forms end 126 (e.g., surface, edge or lip); wherein the holder 100 comprises an end 124 and an opposite end 125, and the opposite end 125 comprised in the outlet section 123 forms at least one flow passageway 136, 137, 138, or 139.

Aspect 37. The holder 100 of Aspect 36, wherein the at least one flow passageway 136 comprises four flow passageways 136, 137, 138, and 139.

Aspect 38. The holder 100 of Aspect 36 or 37, wherein the holder 100 comprises an inner surface 130 forming a key 131.

Aspect 39. The holder 100 of any of Aspects 36 to 38, wherein the key 131 is generally rectangular or prism shaped.

Aspect 40. The holder 100 of any of Aspects 36 to 39, wherein the flow-through section 122 comprises an end 126, in turn comprising (e.g., forming) one or more holes 132, 133 for receiving one or more pins 134, 135 for securing the holder 100 in a housing 3200.

Aspect 41. An outer race 450 for an autoclave reactor 3000, alone or in combination with any of Aspects 27 to 40, comprising: a body 445 having a generally annulus shape (e.g., cylinder) 451 and having a top 447 and a bottom 449; an inner (cylindrical) surface 452 comprising (e.g., forming) one or more conduits 453 (e.g., one or more rectangular grooves extending a radial depth 467 into the inner surface 452 and extending an axial length 465 from the top 447 to the bottom 449); one or more radial bearing elements 454 coupled to the inner surface 452; and one or more thrust bearing elements 458 coupled to a top surface 457.

Aspect 42. The outer race 450 of Aspect 41, wherein the one or more radial bearing elements 454 (e.g., cylindrical buttons or nubs) and one or more thrust bearing elements 458 (e.g., cylindrical buttons or nubs) comprise, independently, a material having a Mohs hardness greater than or equal to about 9.

Aspect 43. The outer race 450 of Aspect 41 or 42, wherein the one or more radial bearing elements 454 and one or more thrust bearing elements 458 comprise tungsten carbide, diamond, or a combination thereof.

Aspect 44. The outer race 450 of any of Aspects 41 to 43, wherein the one or more conduits 453 comprises three conduits 453.

Aspect 45. The outer race 450 of any of Aspects 41 to 44, further comprising an outer surface 455 comprising (e.g., forming) a keyway 456 (e.g., one or more rectangular grooves extending a radial depth 471 into the outer surface 455 and extending an axial length 473 from the top 447 to the bottom 449).

Aspect 46. A shaft fastener 270 for an autoclave reactor 3000, alone or in combination with any of Aspects 27 to 45, comprising: a body 272 having a generally frusto-conical shape 274 and comprising an inner surface 276 and an outer surface 278, wherein: the inner surface 276 has a first diameter 284 perpendicular to a longitudinal axis L and defines a second diameter 285 of an opening 283 perpendicular to the longitudinal axis L wherein the first diameter 284 is spaced apart axially from the second diameter 285, the outer surface 278 has a first diameter 286 perpendicular to the longitudinal axis L and defines a second diameter 287 of the opening 283 perpendicular to the longitudinal axis L wherein the first diameter 286 is spaced apart axially from the second diameter 287, and the inner surface 276 forms a lip 294 for engaging and securing the shaft fastener 270.

Aspect 47. The shaft fastener 270 of Aspect 46, wherein the second diameter 285 defined by the inner surface 276 and the second diameter 287 defined by the outer surface 278 are substantially equal forming the opening 283 having a generally cylindrical curved surface.

Aspect 48. The shaft fastener 270 of Aspect 46 or 47, wherein the second diameter 285 of the inner surface 276 has a lesser diameter than the second diameter 287 of the outer surface 278 forming the opening 283 having a substantially truncated conical shape.

Aspect 49. The shaft fastener 270 of any of Aspects 46 to 48, wherein the second diameter 285 of the inner surface 276 has a greater diameter than the second diameter 287 of the outer surface 278 forming the opening 283 having a substantially inverse truncated conical shape.

Aspect 50. The shaft fastener 270 of any of Aspects 46 to 49, wherein the inner surface 276 and the outer surface 278 skew in an axial direction from the first diameter 284 to the second diameter 287.

Aspect 51. The shaft fastener 270 of any of Aspects 46 to 50, wherein the inner surface 276 and the outer surface 278 diverge in an axial direction from the first diameter 284 to the second diameter 287.

Aspect 52. The shaft fastener 270 of any of Aspects 46 to 50, wherein the inner surface 276 and the outer surface 278 converge in an axial direction from the first diameter 284 to the second diameter 287.

Aspect 53. The shaft fastener 270 of any of Aspects 46 to 49, wherein the inner surface 276 and the outer surface 278 are generally parallel in an axial direction from the first diameter 284 to the second diameter 287.

Aspect 54. A shaft fastener 270 for an autoclave reactor 3000, alone or in combination with Aspects 27 to 45, comprising: a body 272 having a generally frusto-conical shape 274, wherein the body 272 comprises an inner surface 276 and an outer surface 278 and the inner surface 276 and the outer surface 278 skew in a general direction of a fluid flow 289 exiting the autoclave reactor 3000.

Aspect 55. The shaft fastener 270 of Aspect 54, wherein the inner surface 276 and the outer surface 278 diverge in the general direction of the fluid flow 289 exiting the autoclave reactor 3000.

Aspect 56. The shaft fastener 270 of Aspect 54, wherein the inner surface 276 and the outer surface 278 converge in the general direction of the fluid flow 289 exiting the autoclave reactor 3000.

Aspect 57. The shaft fastener 270 of any of Aspects 54 to 56, wherein the shaft fastener 270 has an end 280 and an opposite end 282, and the end 280 has a first diameter 286 and the opposite end 282 defines a second diameter 287.

Aspect 58. The shaft fastener 270 of any of Aspects 54 to 57, wherein the opposite end 282 forms an opening 283 defined by the second diameter 287, and the opening 283 is defined as a generally cylindrical curved surface.

Aspect 59. The shaft fastener 270 of any of Aspects 54 to 57, wherein the opposite end 282 forms an opening 283 defined as substantially truncated conical.

Aspect 60. The shaft fastener 270 of any of Aspects 54 to 57, wherein the opposite end 282 forms an opening 283 defined as substantially inverse truncated conical.

Aspect 61. The shaft fastener 270 of any of Aspects 54 to 60, wherein the outer surface 278 forms an angle 291 with respect to horizontal H greater than an angle 292 of the inner surface 276 defined with respect to horizontal H.

Aspect 62. The shaft fastener 270 of any of Aspects 54 to 60, wherein the outer surface 278 forms an angle 291 with respect to horizontal H lesser than an angle 292 of the inner surface 276 defined with respect to horizontal H.

Aspect 63. The shaft fastener 270 of any of Aspects 54 to 61, wherein the outer surface 278 forms an angle 291 with respect to horizontal H of about 38 degrees to about 42 degrees and the inner surface 276 forms an angle 292 with respect to horizontal H of about 28 degrees to about 32 degrees.

Aspect 64. The shaft fastener 270 of any of Aspects 54 to 63, wherein the shaft fastener 270 forms a lip 294 at an end 280 for engaging and securing the shaft fastener 270.

Aspect 65. A shaft fastener 270 for an autoclave reactor 3000, alone or in combination with Aspects 27 to 45, a body 272 having a generally frusto-conical shape 274, wherein the body 272 comprises an inner surface 276 and an outer surface 278, and the inner surface 276 and the outer surface 278 are generally parallel in the general direction of a fluid flow 289 exiting the autoclave reactor 3000.

Aspect 66. The shaft fastener 270 of Aspect 65, wherein the shaft fastener 270 has an end 280 and an opposite end 282, and the end 280 has a first diameter 286 and the opposite end 282 defines a second diameter 287.

Aspect 67. The shaft fastener 270 of Aspect 65 or 66, wherein the opposite end 282 forms an opening 283 defined by the second diameter 287, and the opening 283 is defined as a generally cylindrical curved surface.

Aspect 68. The shaft fastener 270 of Aspect 65 or 66, wherein the opposite end 282 forms an opening 283 defined as substantially truncated conical.

Aspect 69. The shaft fastener 270 of Aspect 65 or 66, wherein the opposite end 282 forms an opening 283 defined as substantially inverse truncated conical.

Aspect 70. The shaft fastener 270 of any of Aspects 65 to 69, wherein the shaft fastener 270 forms a lip 294 at an end 280 for engaging and securing the shaft fastener 270.

Aspect 71. A process for making low density polyethylene (LDPE), comprising: mixing, with an agitator assembly 3100 contained in a housing 3200 of an autoclave reactor 3000, a reaction medium to form the LDPE in the autoclave reactor 3000, wherein the agitator assembly 3100 is supported by (e.g., coupled to) a flow-through thrust and radial bearing assembly 1000 that is positioned in the housing 3200 of the autoclave reactor 3000; and removing the reaction medium and the LDPE from the autoclave reactor 3000 via a first flow channel 170 and an annular passage 102, wherein the first flow channel 170 is formed between an inner race 400 and a holder 100 of the flow-through thrust and radial bearing assembly 1000 to pass a first part/portion 174 of the reaction medium and the LDPE past the plurality of bearing elements 350 and 430, and the annular passage 102 is formed outside the holder 100 and inside the housing 3200, and communicates with a flow passageway 136, 137, 138, or 139 underneath at least a portion of the holder 100 and an outer race 450 to pass a second part/portion 176 of the reaction medium and the LDPE from the autoclave reactor 3000 for controlling a temperature of a component of the autoclave reactor 3000 (e.g., the flow-through thrust and radial bearing assembly 100) by passing the first part/portion 174 through the plurality of bearing elements 350 and 430 for preventing over-polymerization and degradation of the LDPE.

Aspect 72. The process of Aspect 71, wherein the first part/portion 174 and second part/portion 176 have a combined total volume flow rate 178 through the autoclave reactor 3000, and a volume flow rate of the first part/portion 174 is at least about 10%, by volume flow rate, of the total volume flow rate 178.

Aspect 73. The process of Aspect 71 or 72, wherein the volume flow rate of the first part/portion 174 is less than or equal to about 50%, by volume flow rate, of the total volume flow rate 178.

Aspect 74. The process of any of Aspects 71 to 73, wherein the volume flow rate of the first part 174 is about 20% to about 40%, by volume flow rate, of the total volume flow rate 178.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A holder for a flow-through thrust and radial bearing comprising an outer race and an inner race, wherein each of the outer race and the inner race has a plurality of bearing elements comprising one or more superhard materials, the holder comprising:
an inlet holding section, a flow-through section, and an outlet section;
wherein the inlet holding section is formed in an end of the holder and is configured to receive and hold the outer race of the flow-through thrust and radial bearing;
wherein the flow-through section is formed in a middle of the holder between the inlet holding section and the outlet section, wherein the flow-through section has an end fluidly connected to the inlet holding section and has an inner wall tapered to form a flow channel between the inner wall and a bottom of the flow-through thrust and radial bearing; and
wherein the outlet section is formed in an opposite end of the holder and is fluidly connected to an opposite end of the flow-through section.

2. The holder of claim 1, wherein a diameter of the inlet holding section is greater than a diameter of the outlet section.

3. The holder of claim 1, wherein the end of the flow-through section has a diameter that is less than a diameter of the inlet holding section.

4. The holder of claim 1, wherein the opposite end of the flow-through section has a diameter that is less than the diameter of the end of the flow-through section.

5. The holder of claim 1, wherein the inlet holding section has a cylindrical shape, wherein the flow-through section has a conical shape, and wherein the outlet section has a cylindrical shape.

6. The holder of claim 1, wherein no holes or passages or flow channels are formed in a body of the holder.

7. A flow-through thrust and radial bearing assembly comprising:
a flow-through thrust and radial bearing comprising an outer race and an inner race, wherein each of the outer race and the inner race has a plurality of bearing elements comprising one or more superhard materials; and
a holder for the flow-through thrust and radial bearing, wherein the holder comprises:
an inlet holding section formed in an end of the holder, wherein the inlet holding section is configured to receive and hold the outer race of the flow-through thrust and radial bearing;
a flow-through section formed in a middle of the holder, wherein the flow-through section has an end fluidly connected to the inlet holding section and has an inner wall tapered to form a first flow channel between the inner wall and a bottom of the inner race of the flow-through thrust and radial bearing; and
an outlet section fluidly connected to an opposite end of the flow-through section.

8. The flow-through thrust and radial bearing assembly of claim 7, wherein a second flow channel is formed between the outer race and the inner race, wherein the second flow channel is fluidly connected to the first flow channel.

9. The flow-through thrust and radial bearing assembly of claim 7, wherein the first flow channel is fluidly connected to the outlet section.

10. The flow-through thrust and radial bearing assembly of any of claim 7, wherein the one or more superhard materials comprises polycrystalline diamond, polycrystalline cubic boron nitride, silicon carbide, tungsten carbide, tantalum carbide, other carbides exhibiting a hardness at least equal to that of tungsten carbide, or combinations thereof.

11. The flow-through thrust and radial bearing assembly of any of claim 7, further comprising:
a shaft fastener connected to a bottom of the inner race.

12. The flow-through thrust and radial bearing assembly of claim 11, wherein the shaft fastener extends through the flow-through section of the holder and into the outlet section.

13. The flow-through thrust and radial bearing assembly of claim 11, wherein the first flow channel extends between an outer surface of the shaft fastener and the inner wall of the flow-through section of the holder.

14. An autoclave reactor comprising:
a housing having a top, a bottom, and a vessel body connected between the top and the bottom;
an agitator assembly contained within the housing, wherein the agitator assembly comprises a motor and a shaft coupled to the motor;
a flow-through thrust and radial bearing connected to a bottom end of the shaft, wherein the flow-through thrust and radial bearing comprises an outer race and an inner race, wherein each of the outer race and the inner race has a plurality of bearing elements comprising one or more superhard materials; and
a holder positioned on a bottom of the housing, wherein the holder comprises:
an inlet holding section formed in an end of the holder, wherein the inlet holding section is configured to receive and hold the outer race of the flow-through thrust and radial bearing;
a flow-through section formed in a middle of the holder, wherein the flow-through section has an end fluidly connected to the inlet holding section and has an inner wall tapered to form a first flow channel between the inner wall and a bottom of the inner race of the flow-through thrust and radial bearing; and
an outlet section fluidly connected to an opposite end of the flow-through section.

15. The autoclave reactor of claim 14, wherein the bottom of the housing comprises a reactor outlet, wherein the outlet section of the holder is fluidly connected to the reactor outlet.

16. The autoclave reactor of claim 14, wherein the motor is free-floating in the housing.

17. The autoclave reactor of any of claim 14, wherein the agitator assembly is not connected to the top of the housing.

18. The autoclave reactor of any of claim 14, wherein the agitator assembly is connected to the top of the housing.

19. A process for making low density polyethylene (LDPE), comprising:
mixing, with an agitator assembly contained in a housing of an autoclave reactor, a reaction medium to form the LDPE in the autoclave reactor, wherein a bottom of the agitator assembly is coupled to a flow-through thrust and radial bearing assembly that is positioned on a bottom of the housing of the autoclave reactor; and
removing the reaction medium and the LDPE from the autoclave reactor via a first flow channel formed between an inner race and a holder of the flow-through thrust and radial bearing assembly and a second flow channel formed between the inner race and an outer race of the flow-through thrust and radial bearing assembly.

20. The process of claim 19, wherein each of the outer race and the inner race has a plurality of bearing elements comprising one or more superhard materials.
